(19) United States
(12) Patent Application Publication
(10) Pub. No.: US 2024/0073070 A1
(43) Pub. Date: Feb. 29, 2024

(54) Frequency and/or Time Transfer Apparatus, System and Method

(71) Applicant: NPL Management Limited, Teddington (GB)

(72) Inventor: Jochen Kronjaeger, Braunschweig (DE)

(21) Appl. No.: 18/467,016

(22) Filed: Sep. 14, 2023

Related U.S. Application Data
(63) Continuation of application No. PCT/GB2022/050678, filed on Mar. 17, 2022.

(30) Foreign Application Priority Data
Mar. 17, 2021 (GB) 2103703.1

(51) Int. Cl. H04L 27/20

(52) U.S. Cl. CPC H04L 27/2007; H04L 27/2096

(57) ABSTRACT

A frequency and/or time transfer apparatus, including a modulator system is disclosed. The modulator system includes a port for providing a first modulated signal to a remote location via a communication path and for receiving a second modulated signal from the remote location via the communication path. The modulator system is configured in operation to utilise a first modulation signal to produce the first modulated signal, the first modulated signal comprising the first modulation signal imprinted onto a first carrier signal, and to provide a reverse modulation for the second modulated signal. The first modulation signal is periodic. There exists a reversing modulation signal which reverses and is reversed by the first modulation signal.

### CROSS-REFERENCE TO RELATED APPLICATIONS

This application is a continuation of International Application PCT/GB2022/050678 having a filing date of Mar. 17, 2022, entitled “Frequency and/or Time Transfer Apparatus, System And Method”, which is related to and claims priority benefits from GB patent application 2103703.1 filed on Mar. 17, 2021. This application also claims foreign priority benefits from the 2103703.1 application. The '678 and '703.1 applications are hereby incorporated by reference herein in their entireties.

### FIELD OF THE INVENTION

The present invention relates to apparatus, systems, and methods for frequency and/or time transfer, for example for optical frequency and/or time transfer.

The project leading to this application has received funding from the EMPIR programme co-financed by the Participating States and from the European Union's Horizon 2020 research and innovation programme

Optical frequency transfer utilises ultrastable laser light transmitted through optical fibre in order to compare or disseminate frequency, with several orders of magnitude better stability and accuracy than traditional satellite-based techniques. For example, optical frequency transfer enables comparison of optical atomic clocks across hundreds of kilometres distance. Optical frequency transfer uses bidirectional transmission within the same fibre, in contrast to normal telecommunication applications.

In other words, optical fibre links enable dissemination of frequency references and comparison of optical clocks across hundreds of kilometres with unrivalled stability and accuracy. See Foreman et al., “Remote transfer of ultrastable frequency references via fiber networks” Review of Scientific Instruments 78, 021101 (2007). See also Matveev et al., “Precision Measurement of the Hydrogen 1S-2S Frequency via a 920-km Fiber Link” Phys. Rev. Lett. 110, 230801 (2013). See also Insero et al, “Measuring molecular frequencies in the 1-10 gin range at 11-digits accuracy” Scientific Reports 7, 12780 (2017). See also Guillou-Camargo et al., “First industrial-grade coherent fiber link for optical frequency standard dissemination” Appl. Opt., AO 57, 7203-7210 (2018). See also Lisdat et al., “A clock network for geodesy and fundamental science” Nature Communications 7, 12443 (2016). See also Delva et al., “Test of Special Relativity Using a Fiber Network of Optical Clocks” Phys. Rev. Lett. 118, 221102 (2017).

To effectively suppress Doppler shifts caused by a fluctuating propagation delay, optical frequency transfer links stabilize the round-trip delay, based on the assumption that it equals twice the one-way delay. This requires that the forward and return signals share the same optical path. Fibre links for optical frequency transfer, including optical amplifiers and all other optical components, therefore operate fully bidirectionally.

Dark fibre circuits used for optical frequency transfer often suffer from imperfections, such as splices and connectors, that cause reflections. In addition, Rayleigh scattering occurs even in the absence of imperfections. Light scattered or reflected twice co-propagates and interferes with the original beam, leading to random intensity fluctuations. The effect is compounded by bidirectional EDFAs and can disrupt the phase-locked loops employed to stabilize the link.

Solutions so far have attacked this issue by partly breaking the bidirectionality of the transmission using Brillouin amplification, by breaking the link up into shorter links using a repeater station, and by making the forward and backward propagating light distinguishable using wavelength multiplexing. See Raupach et al., “Brillouin amplification supports 1×10⁻²⁰ uncertainty in optical frequency transfer over 1400 km of underground fiber,” Phys. Rev. A 92, 021801 (2015); Chiodo et al., “Cascaded optical fiber link using the internet network for remote clocks comparison,” Opt. Express, OE 23, 33927-33937 (2015); and Krehlik et al., “ELSTAB—Fiber-Optic Time and Frequency Distribution Technology: A General Characterization and Fundamental Limits,” IEEE Transactions on Ultrasonics, Ferroelectrics, and Frequency Control 63, 993-1004 (2016).

For optical frequency transfer, Fibre Brillouin Amplifiers (FBA) or Relay laser Stations (RLS) are needed for selectively allowing unidirectional transmission only. These are highly complex, research-grade instruments which are only starting to be commercially available. Ensuring splices and connectors have low reflectivity, which can in principle be achieved by careful working and thorough checking, will reduce double scattering. However this is not always practical with leased dark fibres or even shared fibres. Reducing EDFA gain will reduce the impact of double scattering by preventing build-up, but it will also reduce signal-to-noise and will affect the quality and reliability of frequency transfer.

The term “scattered light” means both Rayleigh scattering and reflections such as those caused by splices, connectors and some faults in the fibre.

The term “double scattering” is used here to capture any process resulting in light reflected twice, i.e. ending up in the original direction of propagation. The underlying processes are Rayleigh scattering, which happens everywhere along an optical fibre, and point reflection from splices or connectors. Double scattering leads to signal fluctuations which can severely limit the usefulness of an optical fibre link.

### SUMMARY OF THE INVENTION

Aspects of the present invention seek to provide an improved frequency and/or time transfer apparatus, system and method.

According to an aspect of the invention, there is provided a frequency and/or time transfer apparatus, including:
(a) a modulator system including:
   (i) a port for providing a first modulated signal to a remote location via a communication path and for receiving a second modulated signal from the remote location via the communication path;
wherein the modulator system is configured in operation to utilise a first modulation signal to produce the first modulated signal, the first modulated signal comprising the first modulation signal imprinted onto a first carrier signal, and to provide a reverse modulation for the second modulated signal;
wherein the first modulation signal is periodic;
wherein there exists a reversing modulation signal which reverses and is reversed by the first modulation signal.

It is to be appreciated that the existence of the reversing modulation signal (even if theoretical and not necessarily directly applied at this apparatus) means that the first modulation signal is of such a kind that it is reversible, in that it can be modulated back out of the first modulated signal to recover the first carrier signal.

The use of an imprinted modulation signal enables the effect of double scattering to be reduced. Doubly scattered signal components will have a different propagation delay from the rest of the signal and therefore embodiments of the invention can ensure that their modulation will be out-of-sync with the rest of the signal when they reach the first frequency and/or time transfer apparatus. The reverse modulation for the second modulated signal can be used to produce a second resultant signal (the term ‘second’ being used for consistency with the naming convention used herein rather than to distinguish it from a first resultant signal) in which the effect of the doubly scattered components is reduced, for example by the doubly scattered components being spread by being out-of-sync with the reverse modulation.

The second resultant signal can be used to detect a carrier signal of the second modulated signal and in some embodiments this can be used to determine a phase shift or frequency shift possibly resulting from the propagation of the first modulated signal from the first frequency and/or time transfer apparatus to the remote location and/or from the propagation of the second modulated signal from the remote location to the first frequency and/or time transfer apparatus. This phase or frequency shift can in some embodiments be used to make a compensatory adjustment to a frequency of the first carrier signal.

Embodiments of the invention are furthermore able to maintain bidirectionality within the same communication path, as may be desired for frequency transfer systems, while mitigating against double scattering effects. In particular, the same modulation signal is used to provide modulation and reverse modulation, thereby assisting with bidirectionality. Furthermore, the existence of the counterpart reversing modulation signal enables it to be used in a synchronised manner at the remote location, allowing the first modulation signal to be used both to modulate an outbound signal and enable the detection of a carrier signal from an inbound signal. In some embodiments the counterpart modulation signal and the first modulation signal are the same, meaning that even without the reversing modulation signal being used at the remote location, the first modulation signal can be used both to modulate an outbound signal and enable the detection of a carrier signal from an inbound signal, for example where the remote location has simply returned the first modulated signal as the second modulated signal.

In some embodiments, the first modulation signal is periodic with a period or a multiple of the period corresponding to twice a propagation delay parameter, the propagation delay parameter relating to a propagation delay between the frequency and/or time transfer apparatus and the remote location.

Because the first modulation signal is periodic the reversing modulation signal is also periodic with the same period.

In some embodiments, the propagation delay parameter corresponds to a propagation delay between the modulator system and the remote location or a modulator system at the remote location.

In some embodiments, the frequency and/or time transfer apparatus is an optical frequency and/or time transfer transceiver apparatus and the modulator system is an optical modulator system.

Preferably, the first and second modulated signals and the first and second carrier signals are light signals.

In some embodiments, the reverse modulation for the second modulated signal is configured in operation to produce a second resultant signal, the apparatus optionally including a detector configured in operation to detect the second resultant signal.

In some embodiments, when, as is preferably the case, the first modulation signal is periodic with a period or a multiple of the period corresponding to twice the propagation delay parameter, the second resultant signal may be, or at least include, a second carrier signal, the second carrier signal being the carrier signal of the second modulated signal. Detecting the second resultant signal can include detecting the second carrier signal, and the apparatus may be configured to determine a frequency, phase shift or frequency shift of the second carrier signal.

In some embodiments, the modulator system is configured in operation to imprint the first modulation signal onto the first carrier signal to produce the first modulated signal.

In some embodiments, the modulator system is configured in operation to imprint the first modulation signal onto the second modulated signal to provide the reverse modulation for the second modulated signal.

In such embodiments, providing the reverse modulation for the second modulated signal can include producing the second resultant signal.

In some embodiments, when, as is preferably the case, the first modulation signal is periodic with a period or a multiple of the period corresponding to twice a propagation delay parameter, imprinting the first modulation signal onto the second modulated signal can recover a carrier signal of the second modulated signal as or in the second resultant signal.

In some embodiments, the reverse modulation for the second modulated signal comprises the first modulation signal imprinted onto the first carrier signal, and the apparatus is configured in operation to direct the second modulated signal and the reverse modulation together to the detector and produce the second resultant signal at the detector.

In some embodiments, the port is a first port, the communication path is a first communication path, and the modulator system includes a second port for receiving the first carrier signal via a second communication path.

In some embodiments, the reverse modulation for the second modulated signal is configured in operation to produce a or the second resultant signal, the apparatus including a filter to substantially isolate a carrier signal of the second modulated signal from the second resultant signal.

In some embodiments, the filter is a bandpass filter or a tracking oscillator.

In some embodiments, the filter is configured in operation to substantially isolate the carrier signal of the second modulated signal after detection of the second resultant signal by the detector.

In some embodiments, the apparatus includes a splitter arrangement configured in operation to split the first carrier signal and direct a first part thereof to the modulator system and a second part thereof to the detector.

In some embodiments, the first and reversing modulation signals are the same.

In embodiments, the first and reversing modulation signals are functions of time.

In some embodiments, the first and/or reversing modulation signals provide phase and/or frequency modulation.

In some embodiments, the first and reversing modulation signals are PSK modulation signals.

In some embodiments, the first and reversing modulation signals use a PRN sequence.

In some embodiments, the first and reversing modulation signals are direct spread spectrum modulation signals.

In some embodiments, the frequency and/or time transfer apparatus includes a laser system configured in operation to provide the first carrier signal.

In some embodiments, the modulator system includes the laser system, and the laser system is configured in operation to produce the first modulated signal.

In some embodiments, the first frequency and/or time transfer apparatus includes a control unit configured in operation to communicate with the detector and/or the filter to determine a frequency or frequency shift of the carrier signal of the second modulated signal, and to adjust a frequency of the first carrier signal in dependence thereon, for example by controlling the laser system to adjust the frequency of the first carrier signal.

In some embodiments, the modulator system is configured to concurrently or synchronously imprint the same signal onto the first carrier signal and the second modulated signal.

In some embodiments, the system is configured so that the first carrier signal and the second modulated signal mutually demodulate at the detector.

According to an aspect of the invention, there is provided a frequency and/or time transfer system, including the frequency and/or time transfer apparatus recited above, as a first frequency and/or time transfer apparatus, and including a second apparatus at the remote location;
wherein the second apparatus is configured in operation to receive the first modulated signal from the first frequency and/or time transfer apparatus via the communication path and to provide the second modulated signal to the first frequency and/or time transfer apparatus via the communication path.

Anything recited for the first frequency and/or time transfer apparatus can in some embodiments be applicable to the second apparatus, with ‘first’ and ‘second’ identifiers interchanged, and noting that the timeshifted reversing modification signal is used in place of the first modulation signal.

In some embodiments, the second apparatus includes:
(a) a modulator system including:
   (i) a port for providing the second modulated signal to the first frequency and/or time transfer apparatus via the communication path and for receiving the first modulated signal from the first frequency and/or time transfer apparatus via the communication path;
wherein the modulator system of the second apparatus is configured in operation to utilise a timeshifted reversing modulation signal to produce the second modulated signal, the second modulated signal comprising the timeshifted reversing modulation signal imprinted onto a second carrier signal, and to provide a reverse modulation for the first modulated signal;
wherein the timeshifted reversing modulation signal is the reversing modulation signal timeshifted by a propagation delay parameter preferably relating to a propagation delay between the first frequency and/or time transfer apparatus and the second apparatus.

In some embodiments, the modulator system of the second apparatus is configured in operation to imprint the timeshifted reversing modulation signal onto the second carrier signal to produce the second modulated signal.

In some embodiments, the modulator system of the second apparatus is configured in operation to imprint the timeshifted reversing modulation signal onto the first modulated signal to provide the reverse modulation for the first modulated signal.

In such embodiments, providing the reverse modulation for the first modulated signal can include producing a first resultant signal. In some embodiments, when, as is preferably the case, the first and reversing modulation signals are periodic with a period or a multiple of the period corresponding to twice a propagation delay parameter, imprinting the timeshifted reversing modulation signal onto the first modulated signal can recover the first carrier signal as or in the first resultant signal.

In some embodiments, the second apparatus includes a laser system configured in operation to provide the second carrier signal.

In some embodiments, the modulator system of the second apparatus is configured in operation to recover the first carrier signal and the second apparatus includes a redirector configured in operation to return the first carrier signal back as the second carrier signal.

In some embodiments, the second apparatus includes a return arrangement, optionally a reflector, configured in operation to return at least part of the first modulated signal to the first frequency and/or time transfer apparatus as the second modulated signal.

In some such embodiments, the return arrangement is configured in operation to return a first part of the first modulated signal as the second modulated signal, and the second apparatus includes a modulator system configured in operation to imprint onto a second part of the first modulated signal a timeshifted reversing modulation signal to produce a first resultant signal, the timeshifted reversing modulation signal being the reversing modulation signal timeshifted by a propagation delay parameter preferably relating to a propagation delay between the first frequency and/or time transfer apparatus and the second apparatus. There can be further components configured to operate on this first resultant signal as recited for other implementations of the second apparatus.

In some embodiments, the communication paths are optical paths, preferably optical fibres.

In some embodiments, the first and second apparatuses are optical frequency and/or time transfer transceiver apparatuses.

In some embodiments, the first and second resultant signals are light signals.

According to an aspect of the invention, there is provided a method, including, at a first frequency and/or time transfer apparatus:
utilising a first modulation signal to produce a first modulated signal for providing to a remote location, the first modulated signal comprising the first modulation signal imprinted onto a first carrier signal, and to provide a reverse modulation for a second modulated signal received from the remote location;
wherein the first modulation signal is periodic;
wherein there exists a reversing modulation signal which reverses and is reversed by the first modulation signal.

The method preferably includes providing the first modulated signal to the remote location.

In some embodiments, producing the first modulated signal includes imprinting onto the first carrier signal the first modulation signal.

In some embodiments, providing the reverse modulation for the second modulated signal includes imprinting the first modulation signal onto the second modulated signal to produce a second resultant signal, preferably to recover a carrier signal of the second modulated signal.

In some embodiments, the reverse modulation for the second modulated signal comprises the first modulation signal imprinted onto the first carrier signal, and the method includes directing the second modulated signal and the reverse modulation for the second modulated signal together to a detector and producing a second resultant signal at the detector.

In some embodiments, the method includes the reverse modulation for the second modulated signal producing a second resultant signal, the method further optionally including detecting the second resultant signal.

In some embodiments, when, as is preferably the case, the first modulation signal is periodic with a period or a multiple of the period corresponding to twice the propagation delay parameter, the second resultant signal may be, or at least include, a second carrier signal, the second carrier signal being the carrier signal of the second modulated signal. Detecting the second resultant signal can include detecting the second carrier signal, and the method may include determining a relative phase, a frequency or a frequency shift of the second carrier signal.

In some embodiments, the method includes determining a frequency or frequency shift of the carrier signal of the second modulated signal, and adjusting a frequency of the first carrier signal in dependence thereon.

In some embodiments, the method includes the reverse modulation for the second modulated signal producing a or the second resultant signal including a carrier signal of the second modulated signal;
wherein the method includes filtering the second resultant signal to isolate the carrier signal of the second modulated signal.

In some embodiments, the filtering includes using a bandpass filter or a tracking oscillator.

In some embodiments, the method includes performing the filtering after detecting the second resultant signal.

In some embodiments, the method includes detecting the first carrier signal and the second resultant signal together. In some embodiments, the method includes at the remote location, receiving the first modulated signal from the first frequency and/or time transfer apparatus, and providing the second modulated signal to the first frequency and/or time transfer apparatus.

In some embodiments, the method includes at a second apparatus, the second apparatus being at the remote location:
utilising a timeshifted reversing modulation signal to provide a reverse modulation for the first modulated signal received from the first frequency and/or time transfer apparatus;
wherein the timeshifted reversing modulation signal is the reversing modulation signal timeshifted by a propagation delay parameter preferably relating to a propagation delay between the first frequency and/or time transfer apparatus and the second apparatus.

In some embodiments, the method includes, at the second apparatus:
producing the second modulated signal and providing it to the first frequency and/or time transfer apparatus, the second modulated signal comprising the timeshifted reversing modulation signal imprinted onto a second carrier signal.

In some embodiments, the method includes the reverse modulation for the first modulated signal producing a first resultant signal and the method optionally includes detecting the first resultant signal.

In some embodiments, the method can include detecting and/or filtering the first resultant signal, and/or recovering a carrier signal therefrom, and optionally performing any other operations as a result thereof, in a corresponding manner to that recited for the second resultant signal.

In some embodiments, producing the second modulated signal includes imprinting onto a second carrier signal the timeshifted reversing modulation signal to produce the second modulated signal.

In some embodiments, providing the reverse modulation for the first modulated signal includes imprinting the timeshifted reversing modulation signal onto the first modulated signal, preferably to recover the first carrier signal.

The method can include varying a signal periodicity of the first and reversing modulation signals to determine an actual propagation delay parameter, for example including optimising the signal-to-noise ratio of the first and/or second recovered carrier signal.

The method can include varying the propagation delay parameter used for the timeshifted reversing modulation signal to determine a synchronisation between the first and second frequency and/or time transfer apparatuses, for example including optimising the signal-to-noise ratio of the first and/or second recovered carrier signal.

The method can include providing time transfer between the first frequency and/or time transfer apparatus and the second apparatus.

According to an aspect of the invention, there is provided a program configured to operate the frequency and/or time transfer apparatus recited above with the method recited above, or configured to operate the frequency and/or time transfer system recited above with the method recited above.

According to an aspect of the invention, there is provided a modulator system or modulator system controller configured to execute the method recited above when operated in a transfer apparatus as recited above.

In addition, anything recited above that the apparatus or system is configured to perform, can be considered to constitute optional steps of the method.

According to an aspect of the invention, there is provided a program product including the program recited above.

According to an aspect of the invention, there is provided machine readable medium including the program recited above in machine readable form.

In some embodiments of the invention, the first and second carrier signals are higher frequency than the first and reversing modulation signals.

In embodiments of the invention, the first and reversing modulation signals are configured to provide spectral broadening.

Some embodiments of the invention utilise an approach based on phase modulation of an optical carrier, exploiting the additional delay of multiply scattered or reflected light compared to directly transmitted light.

Some embodiments of the invention can provide spread spectrum optical frequency and/or time transfer over fibre. Some embodiments can provide a spread spectrum technique to mitigate double scattering in optical frequency and/or time transfer.

Embodiments of the invention can provide or utilise a spread spectrum technique, compatible with optical frequency and/or time transfer over fibre, which suppresses interference by doubly scattered or reflected light. Some embodiments of the technique can easily be added on top of existing setups and an embodiment has been successfully deployed during clock comparisons using the 760 km long London-Paris fibre link. It can achieve an end-to-end stability (MDEV) of 1 to 2×10⁻¹⁵ at 1 s averaging, dropping below 1×10⁻¹⁹ after 10⁴ to 10⁵ s, depending on the time of day.

Some embodiments modulate and demodulate the optical carrier (light) directly and at the same time using a single electro-optical component (external PSK phase modulator), also known as the direct-sequence spread spectrum technique.

Some embodiments provide dissemination of frequency (and/or time) over long-distance fibre networks, where a single fibre is used bidirectionally. Bidirectional optical frequency transfer is known but currently only works well on relatively short, good quality links or requires the use of complex instrumentation mid-link, for example FBA and RLS.

In some embodiments of the invention, the optical modulator systems are external phase modulators and both modulators become part of the bidirectional fibre link. In such embodiments, each phase modulator can be driven in such a way that one undoes the effect of the other, for both directions of propagation.

Some embodiments of the invention include broadening the laser at the transmitter side and de-broadening at the receiver, in such a way that the same components and the same signal acts as the modulator for outgoing light and the demodulator (or reverse modulator) for incoming light.

It is to be noted that any of the features of the optical transfer transceiver apparatus can be applied to one or more optical transfer transceiver apparatuses in the system, and the method of optical frequency and/or time transfer can include performing any operation which a transceiver apparatus or the system is described as being configured to do.

The above statements of aspects of invention and advantageous features of embodiments of the invention are provided in concise form above but are applicable to and can be used to describe one or more of the embodiments described in more detail below.

### BRIEF DESCRIPTION OF THE DRAWINGS

Embodiments of the invention are described below, by way of example only, with reference to the accompanying drawings.

FIG. 1 is a schematic diagram of an embodiment of the invention.

FIG. 2 is a schematic diagram of arrangements according to embodiments of the invention.

FIG. 2a is a schematic diagram of part of a system according to an embodiment of the invention.

FIG. 3 is a schematic diagram of a system according to an embodiment of the invention.

FIG. 3a is a schematic diagram of part of a system according to an embodiment of the invention.

FIG. 4 shows numerical simulations of the effect of local and remote modulation as a function of time shift.

FIG. 5 shows results of an experimental example using an embodiment of the invention.

FIG. 6 is a schematic diagram of an embodiment of the invention.

FIG. 7 is a schematic diagram of an embodiment of the invention.

FIG. 8 is a graph illustrating how an optimal delay is found in an embodiment of the invention.

FIG. 9 is a graph illustrating some results from an embodiment of the invention.

FIG. 10 is a graph illustrating an evolution of performance of time transfer using an embodiment of the invention.

### DETAILED DESCRIPTION OF ILLUSTRATIVE EMBODIMENT(S)

Embodiments of the invention can be used for frequency transfer. Embodiments of the invention can be used for different types of frequency transfer, for example in telecommunications, using microwave frequencies such as microwaves in a waveguide, or even using DC signals. However, preferred embodiments relate to optical frequency transfer, and these are described in more detail below. Optical frequency transfer can be understood as establishing a known relationship between a local optical frequency and a remote optical frequency. The skilled person will appreciate that the optical components of these embodiments can be substituted for appropriate corresponding non-optical components for other types of frequency transfer.

In general, frequency transfer is signal transmission with the purpose of reproducing the same frequency in two locations. For example, given a first oscillator at A and a second oscillator at B, transmitting signals of any kind between A and B with the aim to ensure that the frequency of the first and second oscillator are identical, or the difference or ratio of their frequency is well tracked. The information transmitted is the oscillator frequency itself.

In preferred embodiments of the invention, the frequency (or phase) of transmitted laser light is the quantity of interest. Frequency in this context is just the time derivative of phase, in other words the two quantities are mathematically related in a universal way. If you have one, you automatically have the other as well. Some embodiments can also be used as a method of adding time transfer on top of carrier frequency transfer.

Bidirectionality is used to achieve good accuracy in optical frequency transfer. Therefore any technique used in conjunction with optical frequency transfer maintains bidirectionality, and even more maintains reciprocity (symmetry between directions—same delay from A to B as from B to A). However, the problem of doubly scattered light occurs in bidirection.

A typical optical carrier transfer link involves an acousto-optic modulator (AOM) at both the local and remote end: the local one acts as variable phase delay used to compensate fluctuations of the fibre phase delay, whereas the remote one acts a fixed frequency shifter that helps distinguish scattered light from light that has gone all the way to the end point. It does not, however, distinguish doubly scattered light. The technique according to embodiments of the invention is able to address double scattering and is compatible with standard optical frequency transfer and can easily be added on top of existing setups.

Techniques according to embodiments of the invention can be equally used with two-way optical frequency transfer, where independent lasers transmit counter-propagating light through a single fibre, or combinations of the two. See Bercy et al., “Two-way optical frequency comparisons at 5×10⁻²¹ stability over 100-km telecommunication network fibers,” Phys. Rev. A 90, 061802 (2014). See also Calosso et al., “Frequency transfer via a two-way optical phase comparison on a multiplexed fiber network,” Opt. Lett., OL 39, 1177-1180 (2014).

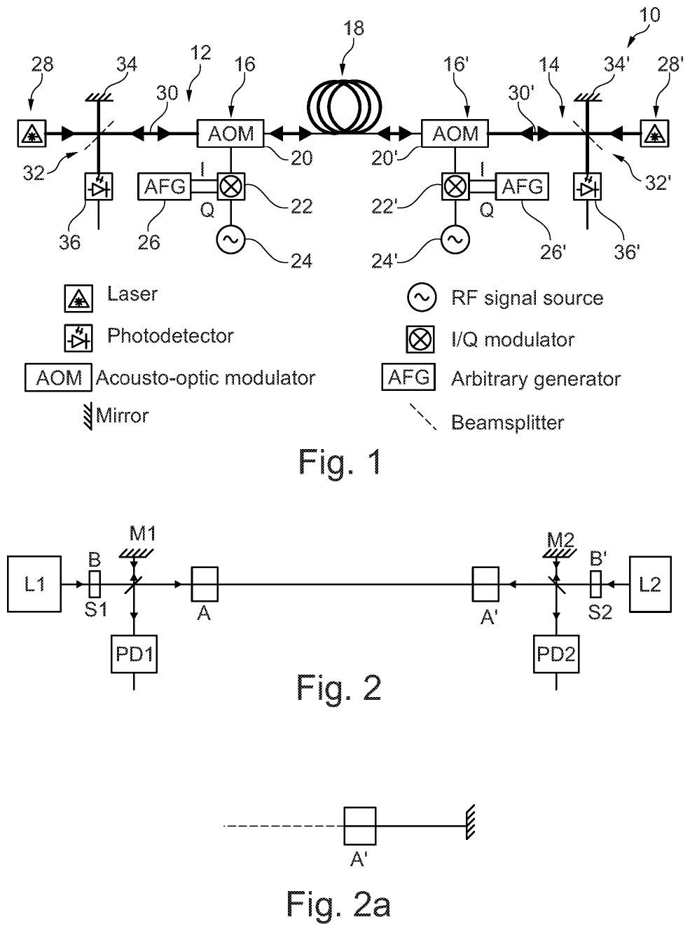

FIG. 1 is a schematic diagram of an embodiment using the two-way scheme.

As described in more detail below, in this embodiment a spread spectrum technique modulates the ultrastable laser light at one end with a pre-defined binary sequence, and de-modulates (reverse modulates) it at the other end using the same but delayed sequence. For directly transmitted light, modulation and de-modulation (reverse modulation) cancel and the ultrastable carrier remerges. Multiply scattered light experienced a different delay and the corresponding signal is spread over a large bandwidth. A bandpass filter is used, for example after heterodyne detection, to transmit only the carrier and reject most of the multiply-scattered signal.

In the technique of the embodiment of FIG. 1, at each end, modulation and de-modulation (reverse modulation) are performed simultaneously using just one modulator and one signal (“reciprocal”, meaning the effect on light passing either way is identical). This means the whole link including the spread spectrum apparatus is fully bidirectional. This is advantageous in order to minimise asymmetries which otherwise cause instability and inaccuracy in optical frequency transfer. In the technique of the embodiment of FIG. 1, light signals are modulated directly, and optically, without optical to electronic conversion.

In more detail, FIG. 1 shows an optical frequency transfer system 10, including a first optical frequency transfer apparatus which in this embodiment is an optical frequency transfer transceiver apparatus 12, which can be considered to be at a local end of the link, and a second apparatus which in this embodiment is a second optical frequency transfer transceiver apparatus 14, which can be considered to be at a remote end of the link. From the perspective of the first optical frequency transfer transceiver apparatus 12, the second optical frequency transfer transceiver apparatus 14 can be considered a remote location.

The first optical frequency transfer transceiver apparatus 12 includes an optical modulator system 16 including a first port, for providing a first modulated light signal to the second optical frequency transceiver apparatus 14 via a communication path and for receiving a second modulated light signal from the second optical frequency transfer transceiver apparatus 14 via the communication path. In this embodiment, the communication path is an optical path, in particular an optical fibre 18, and the first port is coupled to the optical fibre 18.

The optical modulator system 16 includes a second port for receiving a first carrier light signal from a second communication path. In the system of FIG. 1, the second communication path is a second optical path, in particular an optical fibre 30, and the second port is coupled to the optical fibre 30.

In other embodiments, any of the optical fibres 18, 30, 30′ can be omitted and replaced with a different type of suitable communication path for the type of frequency transfer. In embodiments for optical frequency transfer they can be any type of optical path, for example a different type of optical guide, or even air or empty space.

In this embodiment, the optical modulator system 16 is an electro-optical component in the form of an external phase modulator and includes a conventional AOM 20 coupled to an I/Q modulator 22, which in turn is coupled to an RF signal source 24. An arbitrary generator 26 is coupled to the I/Q modulator 22. The optical frequency transfer transceiver apparatus in this embodiment includes a single modulator for modulating both incoming and outgoing light signals.

In this embodiment, the first optical frequency transfer transceiver apparatus 12 includes a laser system 28 configured in operation to provide the first carrier light signal, in particular to generate and output the first carrier light signal such that it passes along the optical fibre 30 and into the second port of the optical modulator system 16.

The first optical frequency transfer transceiver apparatus also includes a detector, in this embodiment a photodetector 36, configured in operation to detect a second resultant light signal output by the optical modulator system 16 in this embodiment via the second port and optical fibre 30. In this embodiment, the detector is configured to detect using heterodyne detection, although this is not essential; for example, non-heterodyne detection can be used in some embodiments. In general, the detector may be any system or process that can be used to distinguish a narrow optical carrier from a spectrally broad optical signal. In some embodiments, spectroscopy can provide the detector.

In this embodiment, the first optical frequency transfer transceiver apparatus 12 includes a splitter arrangement, including a beamsplitter 32 and a mirror 34, configured in operation to split the output of the laser system 28, namely the first carrier light signal, and direct a first part thereof to the optical modulator system 16 via the optical fibre 30 and a second part thereof to the heterodyne detector for comparison with the second resultant light signal. The optical redirection arrangement is also configured in this embodiment to direct the second resultant light signal to the detector, although an optical redirection arrangement may not be necessary for this purpose in every embodiment. Although in this embodiment the optical redirection arrangement includes a beamsplitter and a mirror, other arrangements can be used in other embodiments. The optical redirection arrangement of the embodiment of FIG. 1 is not necessary in every embodiment; it is just one possibility. For example, in embodiments with non-heterodyne detection, it is not necessary for a part of the first carrier light signal to be directed to the detector.

The optical modulator system 16 is configured in operation to utilise a first modulation signal to produce the first modulated light signal, the first modulated light signal comprising the first modulation signal imprinted onto the first carrier light signal. In particular, in this embodiment the optical modulator system 16 is configured in operation to imprint, onto the first carrier light signal, which in this embodiment is received via the optical fibre 30 into the second port, the first modulation signal to produce the first modulated light signal. The optical modulator system 16 is configured in operation to provide the first modulated light signal to the second optical frequency transceiver apparatus 14 via the optical fibre 18.

The apparatus is also configured in operation to provide a reverse modulation for the second modulated signal. In this embodiment, the optical modulator system 16 is configured in operation to imprint, onto the second modulated light signal, which in this embodiment is received via the optical fibre 18 into the first port, the first modulation signal, to provide the reverse modulation for the second modulated signal. In this embodiment, providing the reverse modulation for the second modulated light signal produces the second resultant light signal. The optical modulator system 16 is configured to output the second resultant light signal via the optical fibre 30 from the second port to be detected by the detector.

Imprinting as discussed herein means encoding or modulating such that imprinting a modulation signal onto a carrier light signal to result in a modulated light signal means encoding the modulation signal onto the carrier light signal, or modulating the carrier light signal with the modulation signal, to result in the modulated light signal. Similarly, imprinting a modulation signal onto a modulated light signal to produce a resultant light signal means encoding the modulation signal onto the modulated light signal, or modulating the modulated light signal with the modulation signal, to produce the resultant light signal.

The first modulation signal is periodic with a period or a multiple of the period corresponding to twice a propagation delay parameter, the propagation delay parameter relating to a propagation delay between the first and second optical transfer transceiver apparatus. In other words, the first modulation signal consists of a signal phrase that repeats every period. In this embodiment, the propagation delay parameter corresponds to a propagation delay between the optical modulator system 16 of the first optical frequency transfer transceiver apparatus and the optical modulator system 16′ of the second optical frequency transceiver apparatus.

In addition, there exists a counterpart reversing second modulation signal which reverses and is reversed by the first modulation signal. As explained in more detail below, this means that, in this embodiment, because the first modulation signal is periodic in the manner described above, the imprinting of the first modulation signal onto the second modulated light signal cancels or reverses the modulation of the second modulated light signal to result in the second resultant light signal being or at least including a second carrier light signal while leaving doubly scattered light spread over a large bandwidth, the second carrier light signal being a carrier signal of the second modulated light signal. In other words, the second carrier light signal is recovered.

Because the first modulation signal is periodic, the reversing modulation signal is also periodic with the same period, meaning that it too consists of a signal phrase that repeats every period.

As the skilled person will appreciate, reverse modulation involves the recovery of a continuous wave from a modulated carrier, by modulating the modulated carrier a second time. In embodiments of the invention such as FIG. 1, a second modulation of a modulated signal reverses the effect of a first modulation to recover an unmodulated wave. Although the term demodulation is used interchangeably with reverse modulation in some places in this disclosure, this is different from ‘conventional’ demodulation in which an information-bearing signal is extracted from a modulated carrier wave.

In mathematical terms, ‘conventional’ demodulation and the demodulation (reverse modulation) of embodiments of the invention can be compared in the abstract as follows:

Take x(t)∈{0, 1} to be a continuous time binary signal (either 0 or 1 at any time)

Take e^{-iω}^{₀}^{t} to be a fixed frequency carrier wave of unit amplitude. The process of modulation (here BPSK) can be represented as follows

x(t)→e^{-i(ω}^{₀}^{t+πx(t))}

‘Conventional’ de-modulation can be represented as follows:

e^{-(ω}^{₀}^{t+πx(t))}→x(t)

Reverse modulation can be represented as follows:

e^{-(ω}^{₀}^{t+πx(t))}→e^{-ω}^{₀}^{t}

Returning to the embodiment of FIG. 1, the first and second modulation signals vary over the period; they are functions of time. In this embodiment, the first modulation signal is imprinted onto the first carrier signal and the second modulated light signal synchronously. In other words, the first modulation signal can be represented as M1(t). At time t, M1(t) is imprinted onto both the first carrier signal and the second modulated light signal, having propagated through the optical fibre 18 and thus delayed by the propagation delay. In other words, at any given time, the imprinting onto the first carrier signal arriving at the second port of the optical modulator system 16 is the same as the imprinting onto the second modulated light signal arriving at the first port of the optical modulator system 16. This means the imprinting is reciprocal and performed by a single modulator system, thereby avoiding separate transmit and receive paths which might otherwise cause asymmetry which might adversely impact optical frequency transfer.

The first and second modulation signals are spread spectrum modulation signals, in that they spread or broaden the spectrum of the light on which they are imprinted, causing doubly scattered light to remain spread after demodulation (otherwise referred to as reverse modulation).

As mentioned, the recovery of the second carrier light signal can be described as demodulation. However, as discussed above, it is noted that “demodulation” is conventionally used to describe a process whereby low frequency (“baseband”, i.e. 0 to fmax) data is recovered from a narrow band, high frequency carrier (signal contained within the frequency band f0−fmax to f0+fmax). In contrast, in embodiments of the invention such as that of FIG. 1, when a modulated light signal is received at a transceiver and demodulated, the high frequency signal is compressed from occupying the band f0−fmax to f0+fmax to just the carrier frequency f0. This is more like a second modulation undoing the effect of the first modulation. No baseband data is recovered, only a clean carrier.

As the skilled person will appreciate, the recovered second carrier light signal output by the optical modulator system is at least part of the second resultant light signal that may include other signals, for example resulting from double scattering effects. These other signals will be spread over a large bandwidth as a result of having a different delay from the directly transmitted signal and therefore not being in sync with the demodulation (otherwise referred to as reverse modulation), but may still be present. The first optical transfer transceiver apparatus 12 includes a filter (not shown) configured in operation to filter the second resultant light signal to substantially isolate the second carrier light signal from the second resultant light signal. In this embodiment, the filter is a bandpass filter, but it can be a different type of filter such as a tracking oscillator in other embodiments.

The filter is a system or process with a spectral transmission, or sensitivity, characteristic peaked around the carrier frequency (optical or RF, after heterodyne), and with a width substantially less than that of the spread spectrum, in other words the broadened modulated signal. In other words, a bandpass characteristic with a pass band centred around the carrier and a width substantially less than the spread spectrum.

In this embodiment, the filter is an electronic bandpass filter in the RF domain configured to filter the second resultant light signal after its detection by the detector. In other words, the detector is configured to detect the second resultant light signal including the second carrier light signal and other signals for example from double scattering, and the filter is configured subsequently to filter out those other signals to substantially isolate the second carrier light signal.

However, in other embodiments, the filter can be in the optical domain, for example a narrow spectroscopic feature, a fabry-perot cavity, etc and/or can filter the second resultant light signal before its detection by the detector.

The detector and filter together can be considered a detection arrangement and detecting the second resultant light signal can be said to include filtering it.

In view of the above, detecting the second resultant light signal can be said to include detecting the second carrier signal.

In some embodiments, the apparatus is configured to determine a frequency, phase shift or frequency shift of the second carrier signal as compared to the first carrier signal.

In this “two-way” embodiment, the apparatus 12 includes a recording system (not shown) configured in operation to determine and record a relative phase, a frequency or a frequency shift of the carrier signal of the second modulated signal relative to the first carrier signal, for example for later processing.

In another embodiment, an “active compensation” embodiment, the first frequency transfer transceiver apparatus 12 includes a control unit configured in operation to communicate with the detection arrangement, for example the detector and/or the filter, to determine a relative phase, a frequency or a frequency shift of the carrier signal of the second modulated signal relative to the first carrier signal, and to adjust a frequency of the first carrier signal in dependence thereon. In one example, the frequency of radio frequency source 24 is adjusted to keep the beat frequency detected at 36 constant (thereby compensating any frequency shifts in the transmission fibre 18). It is noted that the terms relative phase and phase shift are used interchangeably. The frequency of the local laser 28 is usually kept constant. It will be noted that adjusting the frequency of source 24 shifts the frequency of both the first carrier signal and the centre frequency of second modulated signal simultaneously.

Other configurations can be constructed in many ways, so that the two above are really just the two prototypical configurations. “Active compensation” and other variants can be derived from the “two-way” scenario by taking the detected frequency (or phase) and using it to feed back to certain operational parameters of the setup. However, this is (a) not central to embodiments of the invention and (b) within the skill of the skilled person. In a typical “two way” setup, nothing is adjusted and the beat frequencies (or phase) detected at 36 and 36′ are recorded. Ultimately it is not relevant to embodiments of the invention how the detected beat signals at 36 and 36′ are used, in other words whether they are simply recorded, or used as the input to an electronic feedback system, or used to directly excite atomic transitions and so on.

In the embodiment of FIG. 1, the second optical frequency transfer transceiver apparatus 14 is similar to the first optical frequency transfer transceiver apparatus 12, comprising similar components configured in a similar way but at the opposite, in this embodiment at the remote, end of the optical fibre 18. The components of the second optical frequency transfer transceiver apparatus are as described for the first optical transfer transceiver apparatus and therefore they are not described in detail to avoid repetition. Components of the second optical frequency transfer transceiver apparatus 14 are given the same numeral as the counterpart component of the first optical frequency transfer transceiver apparatus 12, but distinguished by a prime (′) symbol.

The first port of the optical modulator system 16′ of the second optical frequency transfer transceiver apparatus 14 is for coupling to, and in the system of FIG. 1 is coupled to, the optical fibre 18 for providing the second modulated light signal to the first optical frequency transceiver apparatus 12 via the optical fibre 18 and for receiving the first modulated light signal from the first optical frequency transceiver apparatus 12 via the optical fibre 18.

The second optical frequency transfer transceiver apparatus 14 is configured in operation to utilise the reversing modulation signal timeshifted by the propagation delay parameter to provide a reverse modulation for the first modulated signal.

In this embodiment, the optical modulator system 16′ is configured in operation to imprint the timeshifted reversing modulation signal onto the first modulated light signal to provide the reverse modulation for the first modulated signal, producing a first resultant light signal. The first modulation signal that was applied to the first modulated light signal is thereby reversed to recover the first carrier light signal, which is the carrier light signal of the first modulated light signal, as or in the first resultant light signal.

In this embodiment, the laser system 28′ is configured in operation to provide the second carrier light signal, in particular to generate and output the second carrier light signal such that it passes along the optical fibre 30′ and into the second port of the optical modulator system 16′.

The optical modulator system 16′ is configured in operation to utilise the timeshifted reversing modulation signal to produce the second modulated light signal, the second modulated light signal comprising the timeshifted reversing modulation signal imprinted onto the second carrier light signal. In particular, in this embodiment the optical modulator system 16′ is configured in operation to imprint, onto the second carrier light signal, the timeshifted reversing modulation signal to produce the second modulated light signal. The optical modulator system 16′ is configured in operation to output the second modulated light signal to the first optical frequency transceiver apparatus 12 via the optical fibre 18.

The timeshifted reversing modulation signal is imprinted onto the second carrier signal and the first modulated light signal synchronously. In other words, the reversing modulation signal can be represented as M2(t). At time t, M2(t−τ) is imprinted onto both the second carrier signal arriving at the second port of the optical modulator system 16′ and the first modulated light signal arriving at the first port of the optical modulator system 16′, T being the propagation delay parameter. In other words, at any given time, the imprinting by the optical modulator system 16′ onto the second carrier signal is the same as the imprinting by the optical modulator system 16′ onto the first modulated light signal.

At time t, the first modulated light signal arriving at the optical modulator system 16′ will have had the signal M1(t−τ) imprinted on it, where T is the propagation delay parameter. Since the second modulation signal M2(t) reverses the first modulation signal M1(t) for all times t, the signal M2(t−τ) is imprinted on the first modulated light signal by the optical modulator system in order to reverse M1(t−τ) and recover the first carrier light signal in the first resultant light signal.

The optical modulator system 16′ is configured to output the first resultant signal via the optical fibre 30′ from the second port for detection and filtering in a manner corresponding to that described for the second resultant light signal in the first optical frequency transfer transceiver apparatus. However, in other embodiments, the detector 36′ can be omitted and the light carrier wave recovered can be utilised directly for some kind of measurement or other purpose that needs a narrow carrier, for example some kind of precision spectroscopy.

As described above, the optical modulator system 16 of the first optical transfer transceiver apparatus 12 is configured in operation to imprint onto the second modulated light signal the first modulation signal M1(t). Because the first modulation signal M1(t) is periodic with a period or a multiple of the period being equal to twice the propagation delay parameter, M1(t−2τ)=M1(t). The second modulated light signal output by the optical modulator system 16′ at time t will arrive at the optical modulator system 16 at time t+τ imprinted with M2(t−τ). M1(t+τ)=M1(t−τ)because of the periodicity of M1(t), and therefore M1(t+τ) reverses M2(t−τ) to recover the second carrier light signal in the manner described above.

The first and second carrier light signals are higher frequency than the first and second modulation signals, although this is not essential. The light signals are generally ˜100 THz and modulation signals, being electronic signals, are up to maybe ˜10 GHz at most and often much less. In this embodiment, the first and reversing modulation signals are the same as each other. However, in other embodiments they can be different, as long as they are both periodic in the manner explained above, and as long as they reverse each other. For example, it is possible to have a pair of modulation signals s(t) and s′(t), s not equal s′, so that s(t)*s′(t)=1 and s′(t)*s(t)=1 (where * is the modulation operation, which is usually equivalent to mathematical multiplication).

In preferred embodiments, the first and reversing modulation signals provide phase and/or frequency modulation. In the embodiment of FIG. 1, the first and second modulation signals are direct spread spectrum PSK modulation signals utilising a pseudorandom noise (PRN) sequence, in particular pseudo-random binary phase shift keying (BPSK). However, other types of modulation signals can be used, as long as they are periodic in the manner explained above, and reverse each other. For example, an analogue, continuous signal such as a sinusoidal signal can be used. Nevertheless, pseudo-random binary phase shift keying (BPSK) has been found to be particularly effective.

In this embodiment, the laser systems 28, 28′ are configured to operate continuously, although this is not essential. In other embodiments, pulsed light, for example from an optical frequency comb, consisting of multiple narrow carrier signals, can be used. In this case, each carrier is modulated and demodulated (reverse modulated) as detailed above. In yet another embodiment, a slowly modulated carrier, having sidebands at small offset frequencies, can be used. In this case, the carrier along with its sideband is modulated and demodulated (reverse modulated) as detailed above. The skilled person will appreciate that any carrier signal can be used as long as it can be distinguished in the first and second resultant signal from the broad signal resulting from doubly scattered light.

In this embodiment, optical fibres 18, 30 and 30′ together form a fibre link between the local and remote interferometers, with the interferometer for example being the beamsplitter 32, the mirror 34 and the optical path between them. The optical fibres 18, 30 and 30′ are functionally distinct pieces of fibre, separated by the modulators 16 and 16′.

In the embodiment of FIG. 1 in operation, the laser system 28 provides the first carrier light signal to the optical modulator system 16 and the detector of the first optical transfer transceiver apparatus 12 via the optical fibre 30 and the laser system 28′ provides the second carrier light signal to the optical modulator system 16′ and the detector of the second optical transfer transceiver apparatus 14 via the optical fibre 30′.

The optical modulator system 16 utilises the first modulation signal to produce the first modulated light signal by imprinting the first modulation signal on the first carrier light signal. The optical modulator system 16 provides the first modulated light signal to the second optical transfer transceiver apparatus 14 via the optical fibre 18.

The optical modulator system 16′ utilises the timeshifted reversing modulation signal to produce the second modulated light signal by imprinting the timeshifted reversing modulation signal on the second carrier light signal. The optical modulator system 16′ provides this to the first optical transfer transceiver apparatus 12 via the optical fibre 18.

The first modulated light signal is received at the second optical transfer transceiver apparatus where the optical modulator system 16′ utilises the timeshifted reversing modulation signal to provide a reverse modulation for the first modulated light signal by imprinting the timeshifted reversing modulation signal onto the first modulated light signal, the reverse modulation thereby producing the first resultant light signal, to recover the first carrier light signal.

The second modulated light signal is received at the first optical transfer transceiver apparatus where the optical modulator system 16 utilises the first modulation signal to provide a reverse modulation for the second modulated light signal by imprinting the first modulation signal onto the second modulated light signal, the reverse modulation thereby producing the second resultant light signal, to recover the second carrier light signal.

It will be appreciated that the above imprinting processes are all being performed simultaneously and on an ongoing or continuous basis with the timeshifting of the second modulation signal compensating for the propagation delay.

In this embodiment, the detector of the first optical transfer transceiver apparatus 12 detects the first carrier light signal and the second resultant light signal together. Similarly, the detector of the second optical transfer transceiver apparatus 14 detects the second carrier light signal and the first resultant light signal together.

The filter of the first optical transceiver apparatus 12 filters the second resultant light signal after detection and substantially isolates the second carrier light signal.

In some embodiments, a frequency, phase shift or frequency shift of the second carrier signal relative to the first carrier signal can be determined.

This embodiment is for “two-way optical frequency transfer”, in which both local and remote terminals are equivalent. Each records the relative phase determined from the first/second resultant signals and the second/first carrier signals. In other words, in this embodiment, the apparatus 14 includes a recording system (not shown) configured in operation to determine and record a relative phase, a frequency or a frequency shift of the carrier signal of the first modulated signal relative to the second carrier signal.

In other embodiments, for “active compensation frequency transfer”, a frequency, phase shift or frequency shift of the carrier signal of the first modulated signal relative to the second carrier signal may be determined and a frequency of the second carrier signal adjusted in dependence thereon. In one example, the frequency of the remote laser 28′ is adjusted to keep the beat frequency detected by 36′ constant (thereby mimicking the effect of a simple reflector but with an amplified signal). This makes the remote transceiver 14 effectively a mirror. Part of laser 28′ output may be available to the remote user. Furthermore, the second resultant light signal can be used as described above to detect a carrier signal of the second modulated signal and be used to determine a phase shift or a frequency shift for example resulting from the propagation of the first modulated signal from the first frequency transfer apparatus to the remote location. This phase or frequency shift can be used to make a compensatory adjustment to a frequency of the first carrier signal. For example, the beat detected at 36′ can be kept constant by adjusting the frequency of 28′ at the remote end. The beat detected at 36 can be used to measure the two-way phase shift due to propagation from local to remote and back. The one-way phase shift can be assumed to be one half of the total observed phase shift. The one-way phase shift thus determined can be used to make a compensatory adjustment.

It is noted that corresponding operations to any operations performed on the second resultant signal can be performed on the first resultant signal.

Parts or all of the method can be controlled and operated by a program configured to control and operate the first optical transfer transceiver apparatus, with optionally a further program for the second optical transfer transceiver apparatus, or a program can be configured to control and operate the whole system. The program(s) can be provided on a machine readable medium in machine readable form. One or both optical transfer transceiver modules may include memory and a processor, for example in the control unit where a control unit is included, for executing such a program, or a respective program, or a separate computer system programmed with the program may be configured to control and operate one or more optical transfer transceiver apparatuses or the whole system.

As has been explained above, the spread spectrum technique in the embodiment of FIG. 1 modulates ultrastable laser light injected into both ends of a fibre link with a pre-defined binary sequence, and de-modulates (reverse modulates) it at the opposite ends using the same but delayed sequence. Modulation of input light and demodulation (reverse modulation) of output light are performed simultaneously using the same modulator and the same signal. The delay matches the propagation delay of the fibre link, and the sequence is periodic with twice the propagation delay. An external phase modulator is used at both ends of the fibre to form a bidirectional fibre link in which any treatment to the carrier signal is reciprocal for the receiver to recover only the clean carrier signal. The embodiment of FIG. 1 uses phase modulation in the optical domain to achieve an optical spread-spectrum signal. It uses bidirectional reciprocal modulators, which modulate and de-modulate (reverse modulate) the optical signal at the same time.

As mentioned above, bidirectionality is used to achieve good accuracy in optical frequency transfer. Therefore any technique used in conjunction with optical frequency transfer maintains bidirectionality, and even more maintains reciprocity (symmetry between directions—same delay from A to B as from B to A). In reality, there are always deviations from the ideal. For example in FIG. 1, only the optical fibre 18 from beam splitter to beam splitter is reciprocal. The paths from the lasers to the beam splitters are not, and neither are the paths from the splitters to the mirrors. Preferably, the delay variations of these paths are negligible.

An advantage of embodiments of the invention over transmission of just an optical carrier is that doubly scattered light can be filtered out, leading to reduced amplitude fluctuations and/or higher possible gain settings in optical amplifiers used in the transmission line.

Scattering can occur due to Rayleigh scattering (inherent in fibre) or due to faults (connectors, slices, impurities or defects in the glass). However, a fibre circuit with strongly reflecting faults that is impossible to use with just an optical carrier can work with the technique according to embodiments of the invention. This means less time and money can be spent hunting down and rectifying faults in remote, potentially inaccessible places.

In embodiments of the invention there is no transmit/receive delay asymmetry and no uncompensated paths between the transceivers. This means every part of the transmission system, including modulators/demodulators, is precisely reciprocal. This means the accuracy and stability of optical frequency transfer is not compromised.

Some embodiments of the invention physically recover the narrow, stable light signal, rather than just a numerical value for the phase or frequency shift.

Some other advantages include:

embodiments of the invention can be added on top of an existing carrier-only optical frequency transfer system with minimal effort, and with almost zero impact on its performance (stability and accuracy, see above). Specifically, the AOM (20) and interferometer (32, 34, 36) would already be present in such a system. The AOM (20) may be driven by a fixed frequency in a “two-way” setup, or by a VCO inside a phase-locked loop in an “active compensation” setup. In either case the additional I/Q modulator (22), driven by the additional arbitrary generator (26), which in combination can be referred to as a modulator system controller, can simply be inserted between the AOM and the driving source. A bandpass filter is usually already present after the heterodyne detector, and if not could be added with little difficulty.

Embodiments of the invention can be implemented at the end points only, with no need to make physical changes at remote, potentially inaccessible, potentially multiple points along a fibre link (such as adding special amplifiers that stop doubly-scattered light from accumulating)

The spread spectrum technique of embodiments of the invention is compatible with Erbium-doped fibre amplifiers (EDFAs) and enables long links based only on EDFAs, which is a much simpler and more mature technology than FBA and RLS. For example, of the three roughly 700 km long metrological links in operation between the UK, France and Germany, only the London-Paris one is based on EDFAs alone. Spread spectrum has enabled the use of one the London-Paris fibres, whose signal quality used to be too poor as a result of several strong point reflection, during a recent clock comparison campaign testing an embodiment of the invention.

As mentioned above, some embodiments can also be used as a method of adding time transfer on top of or instead of optical carrier frequency transfer. Some embodiments enable a determination of the propagation delay between transmitter and receiver (through the periodicity condition on the signals) and of the synchronisation between transmitter and receiver (through the delay condition on the signals).

In some embodiments of the invention, the first and second frequency transfer transceiver apparatus can be, respectively, a first and second time transfer transceiver apparatus.

Embodiments of the invention can be configured to determine a difference between a first time signal associated with the first time transfer transceiver apparatus and a second time signal associated with the second time transfer transceiver apparatus. In some embodiments, this can be determined from the period of the first and second modulation signals and a timeshifting applied to the second modulation signal as reckoned using the second time signal.

In some embodiments, a second transceiver signal delay is determined by optimising the signal to noise ratio of the recovered first carrier signal, where the second transceiver signal delay is the timeshifting applied to the second modulation signal as reckoned using the second time signal, and the period for the first and second modulation signals is determined by optimising the signal to noise ratio of the first and second recovered carrier signal.

Propagation delay and synchronisation can be determined by varying signal periodicity and relative delay of the first and reversing modulation signals until the conditions for operation of the optical frequency transfer apparatus presented here are met. This can for example include observing the demodulated (reverse modulated) spectrum and optimising the signal-to-noise ratio of the recovered carrier.

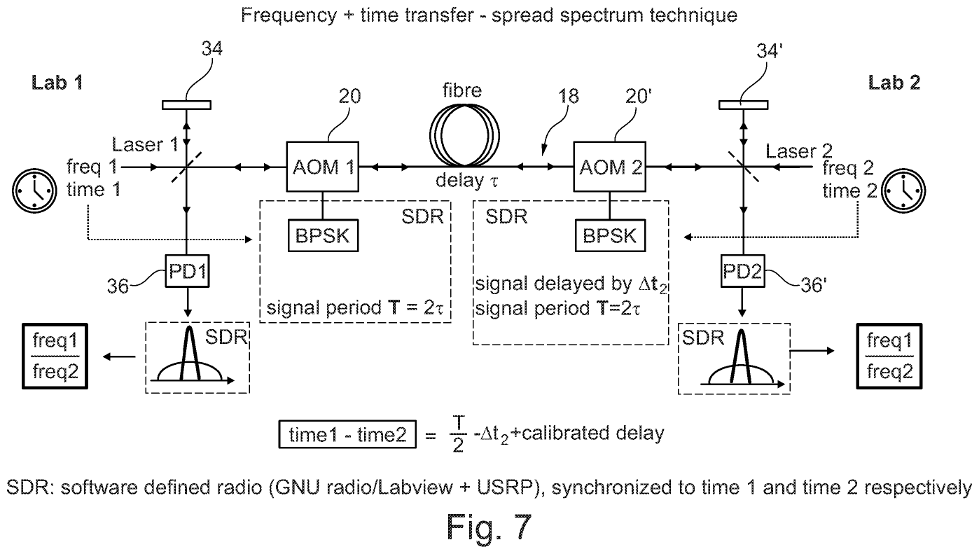

A basic implementation of the technique uses manual adjustment of the delay, which implies accurate reference signals at both end points. although other implementations can be automated, of which an example is discussed below in connection with FIG. 7.

For example, the method can include varying a signal periodicity of the first and reversing modulation signals to determine an actual propagation delay parameter, for example including optimising the signal-to-noise ratio of the first and/or second recovered carrier signal. The method can include varying the propagation delay parameter used for the timeshifted reversing modulation signal to determine a synchronisation between the first and second frequency transfer apparatuses, for example including optimising the signal-to-noise ratio of the first and/or second recovered carrier signal.

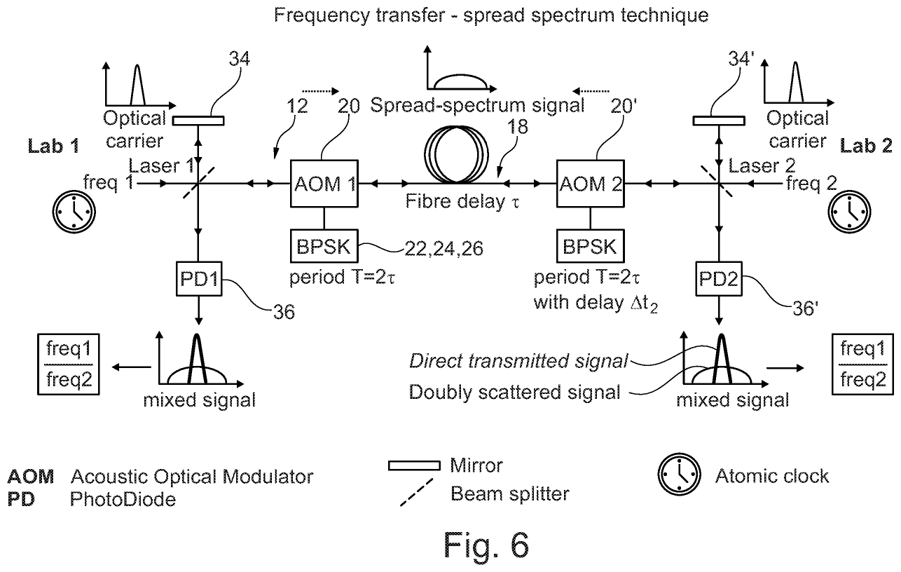

Reference is made to FIGS. 6 to 10 for more detail in connection with time transfer.

FIG. 6 shows a setup for frequency transfer using the spread spectrum technique. FIG. 6 shows the same embodiment as FIG. 1, except that the first and second optical frequency transfer transceiver apparatus are associated with local Atomic clocks. The first optical frequency transfer transceiver apparatus 12 is part of Lab1, and the second optical frequency transfer transceiver apparatus is part of Lab2. Lab1 and Lab2 have local Atomic clocks and compare the frequency of their atomic clocks over fibre. The performance of the frequency transfer is affected by the signals from reflection or Rayleigh scattering (scattered signals in short). The traditional AOM methods can distinguish the single scattered signals, but not doubly (or multiply) scattered signals.

The structure and operation of the frequency transfer of FIG. 6 is described in more detail above in connection with FIG. 1. The link is bi-directional, and signals from Lab1 to Lab2 can be descripted as follow:

Modulating the BPSK signal on the optical carrier of Laser 1at AOM1, will spread the frequency spectrum of the narrow optical carrier to wide band (spread-spectrum signal). By tuning the delay of the BPSK signal at AOM2 to match the transmission delay of the directly transmitted modulated signal from AOM1, the spectrum of the directly transmitted signal will be reversed back to a narrow peak (see the red signal in the spectrum after PD2), while the scattered signals (both single and multiply scattered signals) still remain as spread spectrum as they arrived with different delay and are not properly reverse modulated (see the black signal after PD2). Then one can just filter out the scattered signals and use the directly transmitted signal for frequency transfer measurements. Similar principle of reverse modulation is applied for signals from Lab2 to Lab1:

After the first stage, the delayed BPSK signal from AOM2 will be modulated on the optical carrier of Laser 2, and transmitted to the Lab 1 side. Tune simultaneously the period of the BPSK signal at AOM1 and AOM2, until the directly transmitted modulated signal from AOM2 can be reverse modulated at AOM1, then its spectrum is reversed back to narrow peak, while the scattered signals remain on spread spectrum (see the red and black signals after PD1). Then signals are filtered and used for frequency transfer measurement.

The final frequency transfer measurements are the combination of the two measurements at both ends, which will cancel the instability/noise of the fibre link between two labs.

In the embodiment of FIG. 6, arbitrary waveform generators (AWG) are used to generate BPSK signals. The arbitrary waveform generators are each coupled to a control system, allowing a user to control them (for example through LabVIEW interface).

With these AWGs, the BPSK signal delay and period are carefully tuned, and stopped when a nice peak is seen on the spectrum analyser. If one can record precisely the period, and the signal delay as reckoned using the time signal from the clock associated with Lab2, one can do time transfer at the same time. An automated system for this is shown in FIG. 7. However, a manual system can be used in some embodiments.

As will be appreciated, the following section on time transfer considers not just the real physical values of the propagation delay parameter and periods of the first and second modulation signals, but how these are reckoned using the time signals from the respective clocks. The skilled person will appreciate that these may not be the same. Generally in this disclosure real physical (or ‘universal’) times or time periods are referred to, but in time transfer, the timings as calculated using particular time signals become important.

Referring to FIG. 7, there is shown an embodiment which is the same as the embodiment of FIG. 6, except that Lab 1is a first time transfer transceiver apparatus, and Lab 2 is a second time transfer transceiver apparatus.

In this embodiment, the control systems use Software Defined Radio (SDR): GNU radio or LabVIEW platform plus USRP hardware in order to determine signal delays and periods as described below. However, other systems can be used for this purpose in other embodiments, for example any radio communication system that can flexibly process and output its signal based on its reference time. In this embodiment, the control systems at both ends have clocks synchronized to local Atomic clocks (in this example at their own lab separately), so the time difference of the atomic clocks between the two labs will be involved in the measurements. The local clock to Lab 1 provides a first time signal time 1 and the local clock to Lab 2 provides a second time signal time 2. However, it is not essential that the local clocks of each time transfer transceiver apparatus are Atomic clocks. The time transfer measurements (time1−time2) can be obtained from the recorded signal period and delay as shown in the figure and described below.

In this embodiment, the control system for the second time transfer transceiver apparatus is configured to automatically determine a second transceiver signal delay Δt₂ by optimising the signal to noise ratio of the recovered carrier signal. The second transceiver signal delay Δt₂ is the timeshifting applied to the second modulation signal as reckoned using the second time signal. It will be appreciated that the second transceiver signal delay (Δt₂) is not necessarily the same as the propagation delay parameter discussed elsewhere in this disclosure, since the latter represents a physical time (whether or not specifically measured) whereas the former represents a time measurement reckoned using the second time signal.

The control systems are also configured to automatically determine a period T for the first and second modulation signals by optimising the signal to noise ratio of the first and second recovered carrier signal. This allows for a direct comparison of the time signals from the clocks associated with the first and second time transfer transceiver apparatus.

In the embodiment of FIG. 7, this leads to the following:

Step 1 (Fixing Delay Ate at AOM 16′ When the Reverse Modulation Happens at AOM 16′)

P(time1−τ′₁−τ_{AOM1}−τ)=P(time2−τ′₂−τ_{AOM2}−Δt₂)

Which leads to:

(time1−time2)=τ_{AOM1}−τ_{AOM2})+(τ′₁+τ′₂)+τ−Δt₂

Where time 1 is the time signal from the clock associated with the first time transfer transceiver apparatus, time 2 is the time signal from the clock associated with the second time transfer transceiver apparatus, P is the BPSK signal (the first and second modulation signals—in this embodiment they are the same), τ_{A0M1}, τ_{AOM2} are the modulation delays in the AOM 16 of the first time transfer transceiver apparatus and the AOM 16′ of the second time transfer transceiver apparatus separately, τ′₁, τ′₂ are the signal delays (cables from atomic clock to SDR, cables from SDR to AOM, SDR processing delay) on the side of Lab1 and Lab2 separately.

Step 2 (Fixing Period T at Both AOM 16 and 16′), When the Reverse Modulation Happens at AOM 16

P(time1−τ′₁−τ_{AOM1}−T)=P(time2−τ′₂−τ_{AOM2}−Δt₂−τ)

From step 1=>P(time1−τ′₁−τ_{AOM1}−T)=P(time1−τ′₁−τ_{AOM1}−τ−τ)

→T=2τ

Step 3 (Time Transfer Measurement)

$$( time 1 - time 2 ) = ( {τ}_{AOM 1} - {τ}_{AOM 2} ) + ( {τ}_{1}^{′} - {τ}_{2}^{′} ) + \frac{T}{2} - Δ {t}_{2}$$

It is to be noted that (τ_{AOM1}−τ_{AOM2})+(τ′₁−τ′₂) can be calibrated.

These three steps explain the computation in time transfer for the embodiment of FIG. 7. In step 1, one can see that to reverse the coming modulated signal at AOM2, the local BPSK signal at AOM2 is tuned to have a delay Δt₂ based on the local time signal time2, and the time1−time2 can be expressed by fibre delay τ, tuned BPSK signal delay Δt₂ and other relative signal delays between the setups in the two labs (τ_{AOM1}−τ_{AOM2})+(τ′₁−τ′₂).

In Step 2, the BPSK signal at AOM2 with delay Δt₂ will be modulated on the carrier from Lab2 , and the corresponding modulated signal will be reverse modulated at AOM1 if the signal period T is set correctly. From this step, the fibre delay τ is estimated as

$$\frac{T}{2} .$$

In step 3, time 1−time 2 is obtained after the signal delays (τ_{AOM1}−τ_{AOM2})+(τ′₁−τ′₂) are calibrated.

In this embodiment, as long as the two AOMs, SDRs and the cables are used in pairs, one can do relative calibrations locally before sending one of the AOM and SDR to another remote lab. For example, and although not shown in the figure, in the embodiment of FIG. 7 as implemented experimentally, one clock serves as both clocks of the system so one is comparing the clock to itself, so theoretically time 1−time2= if the calibrated values are correct, so

$$( {τ}_{AOM 1} - {τ}_{AOM 2} ) + ( {τ}_{1}^{′} - {τ}_{2}^{′} ) = - {( \frac{T}{2} - Δ {t}_{2} )}^{1} .$$

Then one can swap the position of AOM1 and AOM2, and repeat step 1-3, one will have

$$- ( {τ}_{AOM 1} - {τ}_{AOM 2} ) + ( {τ}_{1}^{′} - {τ}_{2}^{′} ) = - {( \frac{T}{2} - Δ {t}_{2} )}^{2} .$$

Finally the relative delay of the two AOMs (τ_{AOM1}−τ_{AOM2}), and the remaining relative delay ((τ′₁−τ′₂) can be computed from the combination of these two measurements. However, absolute calibration is recommended for any other link if the AOMs or SDRs were not relatively calibrated in advance.

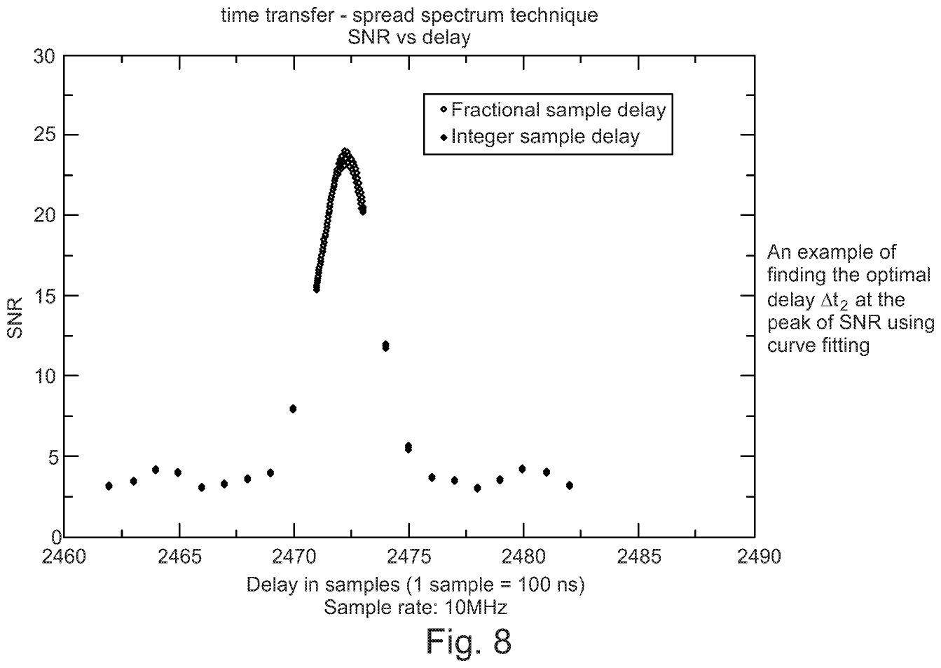

FIG. 8 shows a general idea of how the BPSK optimal delay (Δt₂) as reckoned using the time signal from the clock associated with the second time transfer transceiver apparatus is found, which is used for reverse modulation of the direct transmitted signal.

The delay (Δt₂) is tuned gradually in steps, and the corresponding Signal-noise-ratio (SNR) is recorded, Then after some computation (for example, curve fit to the points), the optimal delay Δt₂ at the highest SNR is obtained.

The tuning of the signal period follows the same principle, and the optimal period T is obtained. Then the time transfer result is computed in step 3 as described above.

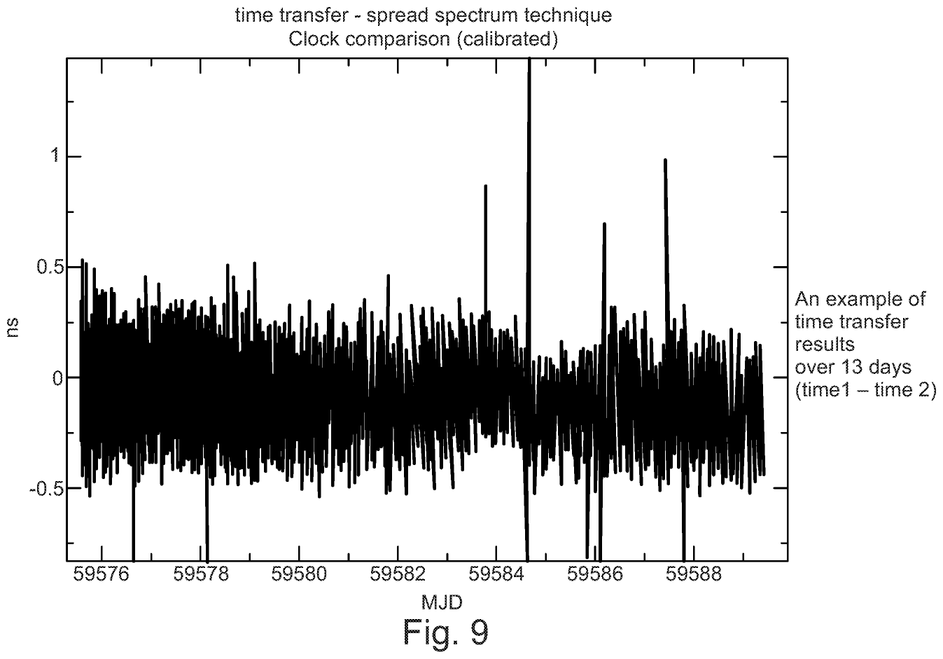

FIG. 9 is an example of the time transfer results from an experiment with 50 km fibre spool. The clock was compared to itself, so the results stay around 0 ns.

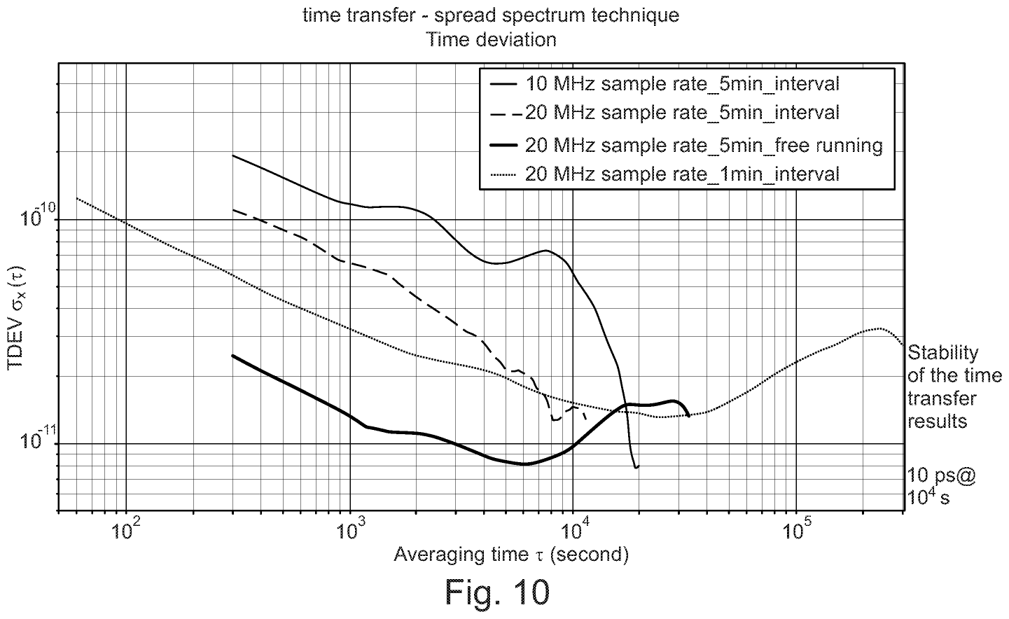

FIG. 10 is an evaluation of the performance of time transfer using spread spectrum technique, in the form of time deviation. 10 ps precision after 10⁴ second averaging has been achieved, but better performances are expected, as these are just initial results.

As the skilled person will appreciate, the embodiment of FIG. 7 can provide both time and frequency transfer. However, it is not essential to provide both; one of time or frequency transfer can be provided without the other in some embodiments. For example, other embodiments described herein can provide frequency transfer without time transfer. Furthermore, the determination of frequency transfer (and/or the components unnecessary for time transfer) can be omitted from the embodiments that provide time transfer in order to provide time transfer without an accompanying frequency transfer.

It is also noted that the embodiment of FIG. 7 provides one way of determining the second transceiver signal delay Δt₂ and the period T for the first and second modulation signals by optimising signal to noise ratios. However, the skilled person will appreciate that there are many optimisation algorithms that can be used in other embodiments. In other words, other ways of determining the second transceiver signal delay Δt₂ and the period T for the first and second modulation signals by optimising the signal to noise ratios can be used in other embodiments.

For example, techniques exist in the field of frequency locking, for example locking a laser to the minimum of an absorption line. Generally, the frequency is modulated periodically, and the relevant quantity (for example transmission) is synchronously detected. This allows to calculate an “error signal” that tells us how far off the optimum (and which way) the laser frequency is, which in turn allows a correction to be applied. Techniques include “top-of-fringe locking”, frequency-locking techniques like Pound-Drever(-Hall), FM spectroscopy, lock-in detection and others, all of which can be used to keep an oscillator locked to the peak of a spectroscopic feature. Reference is made to https://www.toptica.com/application-notes/phase-and-frequency-locking-of-diode-lasers/error-signal-generation/general-error-signal-generation-schemes/.

Furthermore, as the skilled person will appreciate, the modifications to facilitate time transfer can be applied to other embodiments described herein.

It is convenient but not necessary to use the existing AOMs as phase modulators for our technique—dedicated acousto-optic or electro-optic modulators could also be used. Frequency shifters can be used in some embodiments.

Furthermore, as mentioned above, it is not necessary for the two-way scheme of FIG. 1 to be used.

FIG. 2 is a schematic diagram showing two arrangements according to embodiments of the invention: Arrangement A and Arrangement B.

For Arrangement A, the first and second optical transfer transceiver apparatus 12, 14 are as per FIG. 1, including optical modulator systems 16, 16′, labelled in FIG. 2 as A and A′ respectively. The beamsplitters 32, 32′ are labelled as S1, S2, respectively. The mirrors 34, 34′ are labelled as M1, M2, respectively. The photodetectors 36, 36′ are labelled as PD1, PD2, respectively. The laser systems 28, 28′ are labelled as L1, L2, respectively. In this embodiment, the propagation delay parameter is a propagation delay from A to A′, referred to as T.

For cancellation at both ends M_{A}(t+τ)reverses M_{A′}(t) (for clarity: in relation the previously used notation M1 and M2, here M_{A}(t+τ)=M1(t) and M_{A′}(t) =M2(t)) and M_{A′}(t+τ)reverses M_{A}(t). Therefore, where the first and reversing modulation signals are the same, (1) M_{A}(t+τ)=M_{A′}(t) for all t and (2) M_{A′}(t+τ)=M_{A}(t) for all t. Then, substituting t with t+τ in (1) leads to M_{A}(t+2τ)=M_{A′}(t+τ) for all t. Using (2) on the RHS leads to M_{A}(t+2τ)=M_{A}(t) for all t. In other words, MA is 2τ-periodic and as a consequence MA' is also 2τ-periodic. Therefore:
M_{A}(t+2τ)=M_{A}(t), in other words that M_{A} is periodic with period Zr;
M_{A′}(t+τ)=M_{A}(t), in other words A′ is delayed with τ as compared to A;
where M_{A}(t) is the modulation signal applied at optical modulator system A at time t, and M_{A′}(t) is the modulation signal applied at optical modulator system A′ at time t.

This embodiment is independent of the laser source L2. In fact, it is possible to replace the second optical transfer transceiver apparatus 14 with an apparatus as shown in FIG. 2A which consists of the optical modulator A′ and a retroreflector or partial retroreflector (although in a modification this can be a mirror or partial mirror) configured as a redirector configured in operation to return the first resultant signal, which preferably is or includes the recovered first carrier signal, back to the optical modulator system A′ such that the first resultant signal or recovered first carrier signal serves as the second carrier signal.

In the modification of FIG. 2A, where a partial retroreflector is used, part of the first resultant signal can pass through the partial retroreflector, then optionally used for example for direct spectroscopy, in which there may be a second filter which would be the spectroscopic feature being observed, for example an atomic absorption line.

For Arrangement B, the optical modulator systems A, A′ are replaced by optical modulator systems B, B′ as shown in FIG. 2. Other than for the location of the optical modulator systems B, B′, the optical modulator systems B, B′ and other components of the system are as described for Arrangement A. The optical modulator systems B, B′ can be for example be AOM or EOM.

In this embodiment the optical modulator systems B, B′ are positioned immediately laser-side of S1, S2 so that the delays B to S1 and B′ to S2 are negligible.

In this embodiment, the reverse modulation for the second modulated signal comprises the first modulation signal imprinted onto the first carrier signal, and the first optical transfer transceiver apparatus is configured in operation to direct the second modulated signal and the reverse modulation for the second modulated light signal together to the detector PD1 to produce the second resultant signal at the detector PD1. In particular, the optical modulator system B is configured in operation to imprint the first modulation signal onto the first carrier signal in the same manner as for the optical modulator system 16. However, because the optical modulator system B is laser-side of the splitter arrangement, instead of a part of the first carrier light signal being directed to the detector PD1, part of the signal comprising the first modulation signal imprinted onto the first carrier signal is directed to the detector, and this part of the signal is referred to as the reverse modulation in this embodiment.

Furthermore, because the optical modulator system 16 is located laser-side of the splitter arrangement, the second modulated light signal does not pass to the optical modulator system B but is directed to the detector PD1 where it mutually demodulates (reverse modulates) with the reverse modulation to create a beat signal at the detector. This beat signal at the detector is the second resultant signal in this embodiment.

Similarly, the reverse modulation for the first modulated light signal comprises the timeshifted reversing modulation signal imprinted onto the second carrier light signal, and the second optical transfer transceiver apparatus is configured in operation to direct the first modulated light signal and the reverse modulation for the first modulated light signal together to the detector PD2 to produce the first resultant signal at the detector. In particular, the optical modulator system B′ is configured in an analogous manner to the optical modulator system B described above, but with the timeshifted reversing modulation signal, second carrier signal, first modulated light signal, first resultant signal and respective components of the second optical transfer transceiver apparatus substituted for, respectively, the first modulation signal, first carrier signal, second modulated light signal, second resultant signal and components of the first optical transfer transceiver apparatus.

M1, M2 are mirrors to ensure that PD1, PD2 both see B-modulated light from L1 and B′-modulated light from L2. PD1, PD2 each produce the difference frequency signal (beat signal) of the two light signals they receive. These difference signals or beat signals are unmodulated. This means that the modulation signals B, B′, delayed appropriately as they arrive at PD1 or PD2, cancel. Identity and periodicity follow from that.

In this embodiment, as for Arrangement A, the first and reversing modulation signals can be the same or different. Where the first and reversing modulation signals are the same:

M_{B′}(t+τ−2 τ_{SM′})=M_{B}(t)

M_{B}(t+τ−2 τ_{SM′})=M_{B′}(t)

Where τ=delay S1→S2

τ_{SM}=delay S1→M1

τ_{SM′}=delay S2→M2

M_{B}(t) is the modulation signal applied at optical modulator system B at time t, and M_{B′}(t) is the modulation signal applied at optical modulator system B′ at time t.

Therefore

M_{B}(t+2(τ−τ_{SM}−τ_{SM′})=M_{B}(t), in other words the first and reversing modulation signals are periodic with period 2(τ−τ_{SM}−τ_{SM′}).

In other words, in this embodiment, the propagation delay parameter is τ−τ_{SM}−τ_{SM′}.

The skilled person will appreciate that the same propagation delay parameter and periodicity also applies if the first and modulation signals are different.

Of course, in other modifications of Arrangement B, there could be a non-negligible delay between B and S1 and/or B′ and S2, with the propagation delay parameter adjusted accordingly.

In addition, it is possible for the optical modulator systems B and/or B′ to be provided by the respective lasers L1, L2 themselves. In such embodiments, the respective optical modulator system can be said to include the laser system, the laser system being configured in operation to produce the first modulated signal or the second modulated signal by direct laser modulation, for example current, depending on laser type. In embodiments with direct laser modulation and no AOMs, 18, 30 and 30′ would collapse into one.

It is also possible for Arrangement B to be combined with Arrangement A such that Arrangement A applies for one of the first and second apparatus (for example that of FIG. 2, FIG. 2a or modifications thereof) and Arrangement B applies for the other, although the conditions would need to be slightly adapted, which is within the skilled person's expertise.

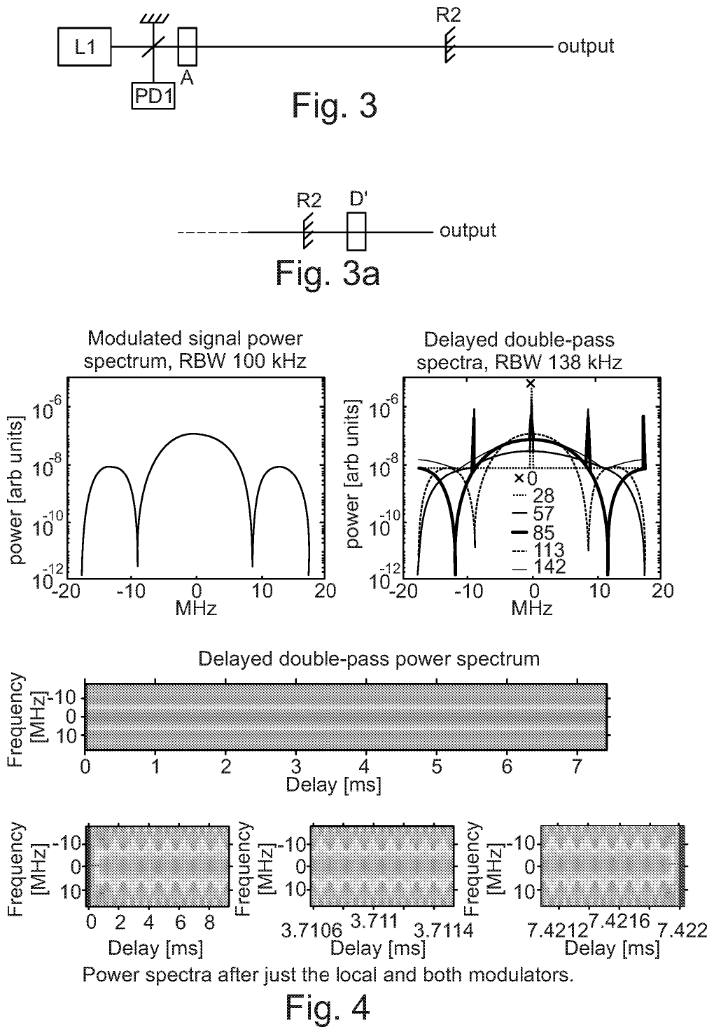

FIG. 3 shows another embodiment of the system in which the first optical transfer transceiver apparatus is configured as per the embodiment of FIG. 1 and Arrangement A of FIG. 2 and the second optical transfer transceiver apparatus is replaced by an apparatus including a return arrangement, in this embodiment a reflector R2, in particular a partial mirror, although it can be a partial retroreflector, configured in operation to return at least part of the first modulated light signal to the first optical frequency transfer transceiver apparatus as the second modulated light signal. In this embodiment, part of the first modulated light signal is allowed to pass through the return arrangement. However, it is not necessary in every embodiment for part of the first modulated light signal to be allowed to pass through; the entire first modulated light signal could all be returned as the second modulated light signal. In a modification, it is possible for the return arrangement to include a phase locked laser provided the locking bandwidth is fast enough to follow the first modulation signal M_{A}, or another means of amplifying the light signal arriving at R2 without substantially changing its spectral composition, for example an erbium-doped fibre amplifier.

In this embodiment, the first modulation signal is periodic and is reversed by itself; in other words the first and reversing modulation signals are the same.

As a further modification, as shown in FIG. 3A, the return arrangement is configured in operation to return a first part of the first modulated light signal as the second modulated light signal, and the apparatus includes an optical modulator system D′ configured in operation to imprint the timeshifted reversing modulation signal (which in this embodiment is the timeshifted first modulation signal) onto a second part of the first modulated light signal to produce the first resultant light signal in the same manner as discussed above for the optical modulator system 16′. There can also be further components configured to operate on this first resultant signal as for the optical modulator system 16′ discussed above. For example, the user at the remote end may want to filter the resultant signal in some way to isolate the carrier. This step is not shown in FIG. 3A. The filtering in this case would be in the optical domain and can for example be a phase-locked laser with a relatively small tracking bandwidth. In another embodiment, it can be a Fabry-Perot cavity, or some other type of optical cavity, or an atomic or molecular transition.

The embodiment of FIGS. 3 and 3A can be advantageous for addressing specific (potentially “virtual”) end points defined by their position (or delay) along the fibre.

### EXAMPLE

An example of the method of the embodiment of FIG. 1 is described in detail below.

Each side of the link is modulated with an identical but time-shifted, periodic, pseudo-random sequence z(t)∈{0, τ} (binary phase-shift keying, BPSK). Modulated light from the local end arrives at the remote end with a delay r and vice versa. Modulating broadens the usually narrow (˜1 Hz at the local end, ˜1 kHz at the remote end due to fibre delay fluctuations) optical carrier into a sinc²-shaped spectrum. At the remote end, it is modulated again, broadening the spectrum even further. Only if the time-shift of the applied sequence matches the propagation delay will the remote modulation exactly cancel the local one, and the broadened spectrum will collapse into a narrow carrier. Any doubly scattered light will arrive with a different delay and remain broadened and can be filtered using electronic bandpass filters or tracking oscillators. For optical carrier frequency transfer, this mechanism operates both ways. For the round trip, this implies z(t)=z(t−2τ)for all times t, i.e. the period of the modulation sequence (or at least a multiple thereof) matches the round-trip delay.

Numerical simulations of the effect of local and remote modulation as a function of time shift have been carried out (FIG. 4). Realistic parameters were used, namely a sequence length of n=2¹⁸ samples, a bit duration of d=4 samples and a sampling rate of around 35 msis , corresponding to a round-trip delay of 2τ≈7.49 ms. Two-sided spectra in the baseband were calculated, so that the x-axes correspond to frequency offset from carrier in the modulated RF signal.

The modulated spectrum (top left) is transmitted over the fibre link. The double-pass spectra result after both modulators and depend on the net delay between the local and remote sequence, i.e. the difference between the time shift applied and the propagation delay τ. The graph (top right) shows how the narrow carrier decays and a broad background emerges as one moves away from perfect alignment. It can be seen that a net delay δ of as little as 28 ns, a quarter of the bit duration, leads to significant loss of signal power in the carrier. The colour-coded plot (bottom) shows the spectrum across the full range of delays of the periodic sequence, with close-ups revealing the defocusing and refocusing at δ=0 and δ=2τ, respectively, as well a breathing-like substructure far off perfect alignment.

### Modulation Sequences

This technique is applied to the 760 km long London-Paris fibre link [6]. See also Delva et al., “Test of Special Relativity Using a Fiber Network of Optical Clocks” Phys. Rev. Lett. 118, 221102 (2017). The local and remote sequences are produced by two arbitrary function generators of the same type and are applied to the RF signal driving the AOMs through I/Q modulators, using the I path only. A fixed sequence of n=2¹⁸ samples were employed with a bit duration of d=4 samples. Samples are output at a rate of around 35 MS/s, corresponding to a round-trip delay of 2τ=7.49 ms. The remote sequence is digitally shifted by

$$\frac{n}{2} = {2}^{17}$$

samples compared to the local one. The bit duration of 114 ns corresponds to a null-to-null bandwidth of the singly modulated spectrum of 17.5 MHz. This is likely to be pushing the modulation bandwidth of the AOMs but was found to provide the best overall level of interference suppression in our case.

Synchronisation

The remote generator is referenced to a 10 MHz signal derived from UTC(OP) and transmitted by optical fibre to the remote end. The generator can be synchronised to a 1 PPS signal from a GPS receiver. At the local end, the generator is referenced to 10 MHz signal from a hydrogen maser tied to UTC(NPL) and can be synchronised to UTC(NPL) through a 1 PPS signal.

### Alignment Procedure

For optimal operation, the periodicity and the time shift at the remote end are matched to the round-trip and one-way delay, respectively, within 100 ns. Synchronising the arbitrary generators to the respective 1 PPS signals is not sufficient to achieve this level of precision. To fine-tune the delay, the reference frequency of one of the generators was temporarily adjusted by 10⁻⁷ (1 Hz at 10 MHz) and one waited for the sequences to align, as determined by the emergence of a narrow carrier observed on a local or remote spectrum analyser. The periodicity is then adjusted by trial and error until a carrier is seen on both local and remote spectrum analysers.

### Results

### Instability and Accuracy

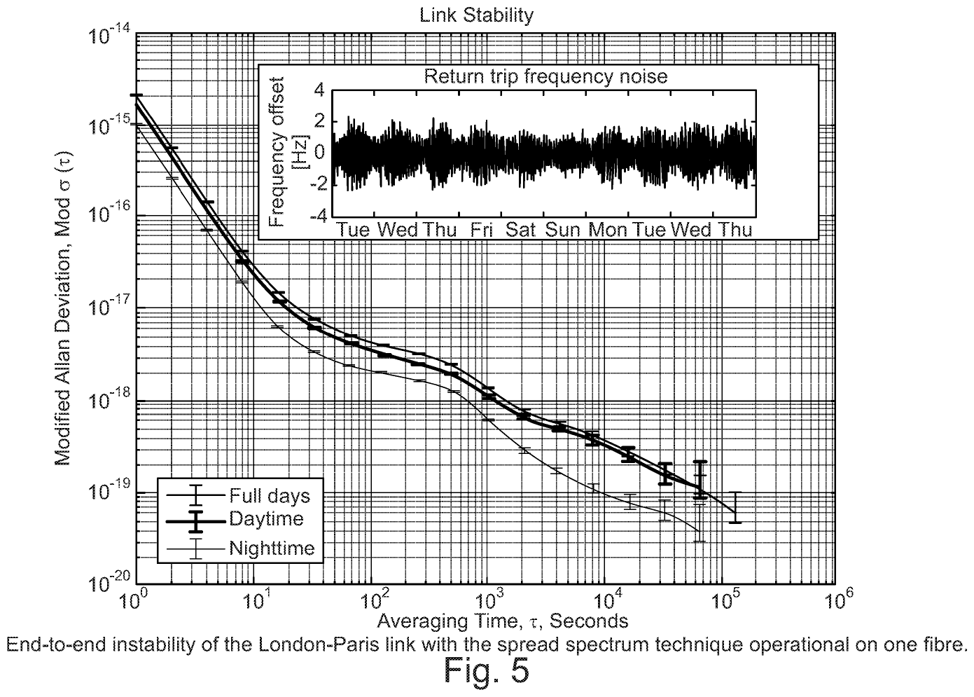

The technique has been successfully deployed during clock comparisons using the London-Paris fibre link. The link consists of two fibres, referred to as Alfa and Bravo, which are individually phase-noise cancelled. To assess the performance of the link “end-to-end”, the Alfa and Bravo links are cascaded, using a Repeater Laser Station [Chiodo et al., Optics Express vol. 23, pp. 33927-33937 (2015); Guillou-Camargo et al, Applied Optics vol. 57, pp. 7203-7210 (2018)] or [8,4], resulting in a loop from NPL (UK) to the remote endpoint in Paris and back to NPL. The Bravo fibre is known to have several points where reflections occur, resulting in strong amplitude fluctuations and a high rate of cycle slips. In fact, end-to-end characterization of the link has only been possible through the use of the technique described herein which in the deployed version was the spread spectrum technique, as the signal quality of the Bravo link is too poor otherwise. An end-to-end stability (MDEV) of 1 to 2×10⁻¹⁵ at 1 s averaging, dropping below 1×10⁻¹⁹ after 10⁴ to 10⁵ s, depending on the time of day was achieved (FIG. 5).

By design, the entire spread-spectrum system is part of the path-length stabilised bi-directional transmission system. Any effect of the modulators on the phase delay, as long as it is reciprocal, should be compensated in the result of the clock comparison, aspects of which are shown in FIG. 5.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

What is claimed:

1. A frequency and/or time transfer apparatus, comprising:
(a) a modulator system comprising:
(i) a port for providing a first modulated signal to a remote location via a communication path and for receiving a second modulated signal from the remote location via the communication path;
wherein the modulator system is configured in operation to utilize a first modulation signal to produce the first modulated signal, the first modulated signal comprising the first modulation signal imprinted onto a first carrier signal, and to provide a reverse modulation for the second modulated signal;
wherein the first modulation signal is periodic; and
wherein there exists a reversing modulation signal which reverses and is reversed by the first modulation signal.

2. The frequency and/or time transfer apparatus of claim 1, wherein the first modulation signal is periodic with a period or a multiple of the period corresponding to twice a propagation delay parameter, the propagation delay parameter relating to a propagation delay between the frequency and/or time transfer apparatus and the remote location.

3. The frequency and/or time transfer apparatus according to claim 1, wherein the frequency and/or time transfer apparatus is an optical frequency and/or time transfer transceiver apparatus and the modulator system is an optical modulator system.

4. The frequency and/or time transfer apparatus of claim 1, wherein the reverse modulation for the second modulated signal is configured to produce a second resultant signal, the frequency and/or time transfer apparatus optionally comprising a detector configured to detect the second resultant signal.

5. The frequency and/or time transfer apparatus of claim 1, wherein the modulator system is configured to imprint the first modulation signal onto the first carrier signal to produce the first modulated signal.

6. The frequency and/or time transfer apparatus according to claim 1, wherein the modulator system is configured to imprint the first modulation signal onto the second modulated signal to provide the reverse modulation for the second modulated signal.

7. The frequency and/or time transfer apparatus according to claim 1, wherein the reverse modulation for the second modulated signal is configured to produce a second resultant signal, the frequency and/or time transfer apparatus comprising a filter to substantially isolate a carrier signal of the second modulated signal from the second resultant signal.

8. The frequency and/or time transfer apparatus according to claim 1, wherein the first modulation signal and the reversing modulation signal are the same.

9. The frequency and/or time transfer apparatus according to claim 1, wherein the first modulation signal and/or the reversing modulation signal provide phase and/or frequency modulation.

10. The frequency and/or time transfer apparatus according to claim 1, wherein the first modulation signal and the reversing modulation signal are direct spread spectrum modulation signals.

11. A frequency and/or time transfer system comprising the frequency and/or time transfer apparatus according to claim 1, as a first frequency and/or time transfer apparatus, and comprising a second apparatus at the remote location; and
wherein the second apparatus is configured to receive the first modulated signal from the first frequency and/or time transfer apparatus via the communication path and to provide the second modulated signal to the first frequency and/or time transfer apparatus via the communication path.

12. The frequency and/or time transfer system of claim 11, wherein the second apparatus includes:
(a) a second modulator system comprising:
(i) a second port for providing the second modulated signal to the first frequency and/or time transfer apparatus via the communication path and for receiving the first modulated signal from the first frequency and/or time transfer apparatus via the communication path;
wherein the modulator system of the second apparatus is configured to utilize a timeshifted reversing modulation signal to produce the second modulated signal, the second modulated signal comprising the timeshifted reversing modulation signal imprinted onto a second carrier signal, and to provide a reverse modulation for the first modulated signal; and
wherein the timeshifted reversing modulation signal is the reversing modulation signal timeshifted by a propagation delay parameter preferably relating to a propagation delay between the first frequency and/or time transfer apparatus and the second apparatus.

13. The frequency and/or time transfer system of claim 12, wherein the modulator system of the second apparatus is configured to imprint the timeshifted reversing modulation signal onto the second carrier signal to produce the second modulated signal.

14. The frequency and/or time transfer system of claim 12, wherein the modulator system of the second apparatus is configured to imprint the timeshifted reversing modulation signal onto the first modulated signal to provide the reverse modulation for the first modulated signal.

15. The frequency and/or time transfer system of claim 11, wherein the second apparatus includes a return arrangement, optionally a reflector, configured to return at least part of the first modulated signal to the first frequency and/or time transfer apparatus as the second modulated signal.

16. A method, comprising, at a first frequency and/or time transfer apparatus:
utilising a first modulation signal to produce a first modulated signal for providing to a remote location, the first modulated signal comprising the first modulation signal imprinted onto a first carrier signal, and to provide a reverse modulation for a second modulated signal received from the remote location;
wherein the first modulation signal is periodic; and
wherein there exists a reversing modulation signal which reverses and is reversed by the first modulation signal.

17. The method of claim 16, comprising the reverse modulation for the second modulated signal producing a second resultant signal comprising a carrier signal of the second modulated signal; and
wherein the method includes filtering the second resultant signal to isolate the carrier signal of the second modulated signal.

18. The method of claim 16, comprising at the remote location, receiving the first modulated signal from the first frequency and/or time transfer apparatus, and providing the second modulated signal to the first frequency and/or time transfer apparatus.

19. The method of claim 18, comprising at a second apparatus, the second apparatus being at the remote location:
utilizing a timeshifted reversing modulation signal to provide a reverse modulation for the first modulated signal received from the first frequency and/or time transfer apparatus; and
wherein the timeshifted reversing modulation signal is the reversing modulation signal timeshifted by a propagation delay parameter preferably relating to a propagation delay between the first frequency and/or time transfer apparatus and the second apparatus.

20. The method of claim 19, comprising, at the second apparatus:
producing the second modulated signal and providing it to the first frequency and/or time transfer apparatus, the second modulated signal comprising the timeshifted reversing modulation signal imprinted onto a second carrier signal.
